(19) United States
(12) Patent Application Publication
(10) Pub. No.: US 2021/0140058 A1
(43) Pub. Date: May 13, 2021

(54) REDUCTION ELECTRODE FOR ELECTROLYSIS AND MANUFACTURING METHOD THEREOF

(71) Applicant: LG CHEM, LTD., Seoul (KR)

(72) Inventors: Hee Jun EOM, Daejeon (KR); Yeon Yi KIM, Daejeon (KR); Myung Hun KIM, Daejeon (KR); Dong Chul LEE, Daejeon (KR); Sang Yun JUNG, Daejeon (KR); Gyo Hyun HWANG, Daejeon (KR); Jong Wook JUNG, Daejeon (KR); Yong Ju BANG, Daejeon (KR)

(21) Appl. No.: 17/052,150

(22) PCT Filed: Jul. 3, 2019
(86) PCT No.: PCT/KR2019/008151

§ 371 Date: Oct. 30, 2020

(30) Foreign Application Priority Data
Jul. 6, 2018 (KR) 10-2018-0078916

(51) Int. Cl. C25B 11/093; C25B 1/34

(52) U.S. Cl. CPC C25B 11/093; C25B 1/34

(57) ABSTRACT

Provided is a reduction electrode for electrolysis and a manufacturing method thereof, the reduction electrode including a metal substrate and an active layer positioned on at least one surface of the metal substrate, wherein the active layer includes ruthenium oxide, a platinum oxide, and a cerium oxide. When the active layer is uniformly divided into a plurality of pixels, the standard deviation of the composition of ruthenium between the plurality of pixels formed by uniformly dividing the active layer is 0.4 or less, and N atoms in the active layer are present in an amount of 20-60 mol % based on ruthenium.

### CROSS-REFERENCE TO RELATED APPLICATIONS

This application is a National Stage Application of International Application No. PCT/KR2019/008151, filed on Jul. 3, 2019, which claims the benefit of priority based on Korean Patent Application No. 10-2018-0078916, filed on Jul. 6, 2018, in the Korean Intellectual Property Office, the disclosures of which are incorporated herein by reference in their entirety.

### TECHNICAL FIELD

The present invention relates to a reduction electrode for electrolysis, the electrode in which the standard deviation of the composition of ruthenium between a plurality of pixels which are formed by uniformly dividing an active layer is 0.4 or less, and a manufacturing method thereof.

### BACKGROUND

A technology of producing hydroxides, hydrogen, and chlorine by electrolyzing low-cost brine such as seawater is widely known. Such an electrolysis process is also referred to as a chlor-alkali process, the performance and reliability of which have been proven through decades of commercial operation.

As a method for electrolyzing brine, an ion exchange membrane method is currently most widely used, the method in which an ion exchange membrane is installed inside an electrolyzer to divide the electrolyzer into a cation chamber and an anion chamber, and using brine as an electrolyte, chlorine gas is obtained from an anode and hydrogen and caustic soda are obtained from a reduction electrode.

The electrolysis of brine is achieved through a reaction as shown in the following electrochemical reaction formulae:

Oxidation electrode reaction: 2Cl^{-→Cl}₂+2e⁻(E⁰=+1.36 V)

Reduction electrode reaction: 2H₂O+2e^{-→}2OH⁻+H₂ (E⁰=−0.83 V)

Entire reaction: 2Cl⁻+2H₂O→2OH⁻+H₂ (E⁰=−2.19 V)

In performing the electrolysis of brine, the electrolytic voltage must be determined by taking the voltage theoretically required for the electrolysis of brine, the overvoltage of each of an oxidation electrode (anode) and a reduction electrode (cathode), the voltage by the resistance of an ion exchange membrane, and the voltage by distance between electrodes into account. Among the above voltages, the overvoltage by an electrode acts as an important variable.

Therefore, methods capable of reducing the overvoltage of an electrode have been studied. For example, as an oxidation electrode, a precious metal electrode referred to as a dimensionally stable anode (DSA) has been developed and used, and as for a reduction electrode, there has been also a demand for development of excellent materials which are low in overvoltage and durable.

As such a reduction electrode, stainless steel or nickel has been mainly used.

In recent years, in order to reduce overvoltage, methods in which the surface of stainless steel or nickel is coated with any one of a nickel oxide, an alloy of nickel and tin, a combination of activated carbon and an oxide, a ruthenium oxide, platinum, and the like have been studied.

In addition, in order to increase the activity of a reduction electrode by adjusting the composition of an active material, methods in which the composition is adjusted using a platinum group metal such as ruthenium and a lanthanide metal such as cerium have also been studied. However, there have been problems in which overvoltage occurs and deterioration caused by a reverse current occurs.

### PRIOR ART DOCUMENT

Patent Document

(Patent Document 1) JP2003-277967A

### DISCLOSURE OF THE INVENTION

### Technical Problem

An aspect of the present invention provides a reduction electrode for electrolysis in which an active material is uniformly distributed in an active layer, so that the reduction electrode has reduced overvoltage and improved lifespan properties while exhibiting high efficiency.

### Technical Solution

According to an aspect of the present invention, there is provided a reduction electrode for electrolysis including a metal substrate and an active layer positioned on at least one surface of the metal substrate, wherein the active layer includes a ruthenium oxide, a platinum oxide, and a cerium oxide, and when the active layer is uniformly divided into a plurality of pixels, the standard deviation of the composition of ruthenium between the plurality of pixels formed by uniformly dividing the active layer is 0.4 or less, and N atoms in the active layer are present in an amount of 20-60 mol % based on ruthenium.

According to another aspect of the present invention, there is provided a method for manufacturing a reduction electrode for electrolysis, the method including a coating step of applying, drying, and heat treating a catalyst composition for a reduction electrode for electrolysis on at least one surface of a metal substrate, wherein the applying is performed by an electrostatic spray deposition method, and the active layer composition for a reduction electrode includes a metal precursor mixture containing a ruthenium-based compound, a platinum-based compound and a cerium-based compound and an organic solvent containing an alcohol-based compound and an amine-based compound.

### Advantageous Effects

A reduction electrode for electrolysis according to the present invention is manufactured by an electrostatic spray deposition method, so that an active material can be uniformly distributed in an active layer therein, and thus, the reduction electrode has reduced overvoltage and improved lifespan properties while exhibiting high efficiency.

### BEST MODE FOR CARRYING OUT THE INVENTION

Hereinafter, the present invention will be described in more detail to facilitate understanding of the present invention.

It will be understood that words or terms used in the specification and claims of the present invention shall not be construed as being limited to having the meaning defined in commonly used dictionaries. It will be further understood that the words or terms should be interpreted as having meanings that are consistent with their meanings in the context and the technical idea of the invention, based on the principle that an inventor can properly define the meaning of the words or terms to best explain the invention.

The term “oxidation electrode” used in the present specification means an electrode in which chlorine gas is generated due to the oxidation reaction of chlorine in the electrolysis of brine. The electrode can be referred to as an anode in that it is an electrode having a positive potential by emitting electrons to cause an oxidation reaction.

Chlorine oxidation reaction: 2Cl⁻→Cl₂+2e⁻(E⁰=+1.36 V)

The term “reduction electrode” used in the present specification means an electrode in which hydrogen gas is generated due to the reduction reaction of hydrogen in the electrolysis of brine. The electrode can be referred to as a cathode in that it is an electrode having a negative potential by receiving electrons to cause a reduction reaction.

Hydrogen reduction reaction: 2H₂O+2e⁻→2OH⁻+H₂ (E⁰=−0.83 V)

1. Reduction Electrode for Electrolysis

The metal substrate can be nickel, titanium, tantalum, aluminum, hafnium, zirconium, molybdenum, tungsten, stainless steel or an alloy thereof. Among the above, nickel is preferable.

The shape of the metal substrate can be the shape of a rod, a sheet, or a plate, and the thickness of the metal substrate can be 50-500 μm. The metal substrate is not particularly limited as long as it can be applied to an electrode typically applied to a chlorine alkaline electrolysis process, and the shape and thickness of the metal substrate can follow the examples proposed above.

The metal substrate can have irregularities formed on the surface thereof.

The active layer includes a ruthenium oxide, a platinum oxide, and a cerium oxide, and when the active layer is uniformly divided into a plurality of pixels, the standard deviation of the composition of ruthenium between the plurality of pixels formed by uniformly dividing the active layer is 0.4 or less, and N atoms in the active layer are present in an amount of 20-60 mol % based on ruthenium.

The standard deviation of the composition of ruthenium is preferably 0.35 or less, and more preferably 0.30 or less.

The standard deviation of the composition of ruthenium indicates the uniformity of an active material in an active layer, that is, the degree to which the active material in the active layer is uniformly distributed. When the standard deviation of the composition of ruthenium is small, it means that the uniformity of an active material in an active layer is excellent. When an active material is not uniformly distributed, the flow of electrons in an electrode is focused on a portion which is low in resistance, so that etching can rapidly occur from a thin portion of an active layer. In addition, electrons can penetrate into holes in the active layer so that deactivation is rapidly progressed and the lifespan of the electrode can be reduced. In addition, the concentration of a reduction electrode electrolyte is lowered around the portion on which the flow of electrons is focused, so that oxygen selectivity, that is, oxygen generation amount is increased, and overvoltage can be increased due to non-uniform current distribution. Furthermore, as the flow of electrons is localized, the load of a separator is not uniform when a cell is driven so that the performance and durability of the separator can be deteriorated.

Here, the standard deviation of ruthenium is calculated by uniformly dividing the reduction electrode for electrolysis into a plurality of pixels, measuring the wt % of ruthenium in each pixel formed by uniformly dividing the reduction electrode, and substituting measured values in the following equations.

Specifically, the reduction electrode for electrolysis is prepared in a 0.6 m in width and 0.6 m in length dimension (width×length=0.6 m×0.6 m) and uniformly divided into 16 pixels to measure the wt % of ruthenium in each pixel using an XRF component analyzer. Thereafter, using the each measured wt % of ruthenium, a dispersion ((V(x)) is calculated through Equation 1 below, and using the dispersion, a standard deviation (σ) is calculated through Equation 2 below.

V(x)=E(x²)−[E(x)]² Equation 1

σ=\sqrt{V(x)} Equation 2

In Equation 1, E(x²) represents an average value of the square of the wt % of ruthenium in the 16 pixels, and [E(x)]² represents the square of the average value of the wt % of ruthenium in the 16 pixels.

Ruthenium is an active material of the reduction electrode for electrolysis, and can be included in an amount of 3-7 mol %, preferably 4-6 mol %, based on 100 mol % in total of metal components in the active layer.

When the above range is met, without affecting the performance of a reduction electrode for electrolysis, the durability thereof can be improved. In addition, since ruthenium is not overly coated on an active layer of a reduction electrode for electrolysis, processing costs and reagent costs can be reduced and the loss of ruthenium can be minimized during activation or electrolysis.

The active layer can include cerium and ruthenium in a weight ratio of 1:1 to 1:1.5, preferably 1:1 to 1:1.3.

When the above range is met, without affecting the performance of a reduction electrode for electrolysis, the durability thereof can be improved.

Platinum can suppress the overvoltage of a reduction electrode for electrolysis and minimize the deviation between the initial performance of the reduction electrode for electrolysis and the performance thereof after a predetermined period of time. As a result, platinum can reduce separate activation processes to the minimum for the reduction electrode for electrolysis, and furthermore, can ensure the performance of the reduction electrode even when an activation process is not performed.

Cerium improves the durability of a reduction electrode for electrolysis, and thus, can minimize the loss of ruthenium in an active layer of an electrode for electrolysis during activation or electrolysis. Specifically, during the activation or electrolysis of a reduction electrode for electrolysis, ruthenium oxide particles containing ruthenium in an active layer are not changed in structure and become metallic ruthenium (Ru), or are partially hydrated and reduced to active species. Also, cerium oxide particles containing cerium in an active layer are changed in structure and form a network with the particles containing ruthenium in the active layer. As a result, the durability of the reduction electrode for electrolysis is improved, thereby preventing the loss of ruthenium in the active layer. In addition, when a reverse current occurs, cerium is eluted at a potential lower than that of ruthenium, thereby preventing a precious metal from eluting.

N atoms contained in the active layer can be derived from an amine-based compound included in an active layer composition during the manufacturing of a reduction electrode. At this time, N atoms can be included in an amount of about 20-60 mol %, preferably 30-55 mol %, and more preferably 35 to 50 mol % based on the moles of a ruthenium component in the active layer.

When N atoms are present in the active layer in the above range, the bed structure of cerium oxide particles derived from a cerium-based compound can be further expanded in an initial driving process to firmly form a network in the active layer, thereby improving the durability of a reduction electrode.

The amine-based compound can be one or more selected from the group consisting of n-octylamine, t-octylamine, isooctylamine, trioctylamine, oleylamine, tributylamine, and cetyltrimethylammonium bromide. Among the above, one or more selected from the group consisting of n-octylamine, t-octylamine, and isooctylamine are preferable.

The reduction electrode for electrolysis according to an embodiment of the present invention can further include a hydrogen adsorption layer positioned on the active layer and including one or more selected from the group consisting of a tantalum oxide, a nickel oxide, and carbon.

The hydrogen adsorption layer is a layer for improving the activity of hydrogen gas generation of a reduction electrode, and can be present in an amount which may not hinder the oxidation-reduction reaction of hydrogen ions or water of a hydrogen layer.

The hydrogen adsorption layer can include pores.

The hydrogen adsorption layer can be positioned such that one or more selected from the group consisting of a tantalum oxide, a nickel oxide, and carbon is present in an amount of 0.1-10 mmol/m².

When the above conditions are met, hydrogen adsorption can be promoted without hindering electrolysis.

The reduction electrode for electrolysis according to an embodiment of the present invention can be used as an electrode for electrolyzing an aqueous solution containing chloride, specifically as a reduction electrode. The aqueous solution containing chloride can be an aqueous solution containing sodium chloride or potassium chloride.

2. Method for Manufacturing Reduction Electrode for Electrolysis

A method for manufacturing a reduction electrode for electrolysis according to an embodiment of the present invention includes a coating step of applying, drying, and heat treating a catalyst composition for a reduction electrode for electrolysis on at least one surface of a metal substrate.

Before performing the coating step, a step of performing pre-treating on the metal substrate can be further included.

The pre-treatment can be performing chemical etching, blasting or thermal spraying on a metal substrate to form irregularities on the surface of the metal substrate.

The pre-treatment can be performed by sand blasting the surface of a metal substrate to form fine irregularities, followed by salt treatment or acid treatment. For example, the pre-treatment can be performed by forming irregularities on the surface of a metal substrate by sand blasting the surface with alumina, immersing the surface in a sulfuric acid aqueous solution, and then washing and drying the surface to form fine irregularities thereon.

The applying is performed by an electrostatic spray deposition method.

The electrostatic spray deposition method is a method in which fine coating liquid particles charged through static current are applied on a substrate. According to the method, a spray nozzle is mechanically controlled to spray a composition for forming an active layer on at least one surface of a metal substrate at a constant rate, and as a result, the composition for forming an active layer can be uniformly distributed on the metal substrate.

The applying is performed by an electrostatic spray deposition method. However, a composition for forming an active layer can be sprayed on a metal substrate with a spraying volume per time of 30-80 ml, preferably 40-70 ml, at a rate of 0.4-1.2 ml/min, preferably 0.6-1.0 ml/min. In this case, an appropriate amount of the composition for forming an active layer can be more uniformly applied on the metal substrate.

At this time, the spraying volume per time is an amount required to spray on both surfaces of the metal substrate one time, and the applying can be performed at room temperature.

When performing the electrostatic spray deposition method, the method must proceed under an appropriate voltage condition since the voltage of a nozzle greatly affects the shape of particles and coating efficiency. When the voltage is too low, particles are split into small pieces, and thus, are not sprayed and exhibit a coating behavior which is almost similar to that of spray coating. Also, when a voltage which is too high is applied, the efficiency of particles being coated on a metal substrate becomes drastically low, so that an appropriate voltage condition is required.

The voltage of a nozzle can be 10 kV to 30 kV, preferably 15 kV to 25 kV In this case, coating can be performed in a uniform content, so that coating performance can be further improved.

In general, a reduction electrode for electrolysis is manufactured by forming an active layer containing reduction electrode reaction active materials on a metal substrate.

At this time, the active layer is formed by applying, drying, and heat treating a composition for forming an active material, the composition containing the active materials.

At this time, the applying is typically performed by any one of doctor blade, die casting, comma coating, screen printing, spray spraying, electrospinning, roll coating, and brushing. However, in this case, it is difficult to uniformly distribute the active materials on a metal substrate, and active materials in an active layer of a reduction electrode manufactured thereby may not be uniformly distributed. As a result, there can be problems in that the activity of the reduction electrode can be deteriorated or the lifespan thereof can be reduced.

In addition, typically, an electrostatic spray deposition method is not applied for reasons such as coating efficiency, and in practical, there are difficulties in that various aspects of properties, such as the uniformity of an active layer and coating efficiency, are not satisfied through an electrostatic spray deposition method.

However, in a method for manufacturing a reduction electrode for electrolysis according to another embodiment of the present invention, the composition for forming an active layer is applied on the metal substrate by an electrostatic spray deposition method, not by a typical method, so that a reduction electrode having active materials uniformly distributed in an active layer therein can be manufactured, and the reduction electrode for electrolysis manufactured thereby can have reduced overvoltage, improved lifespan properties, and suppressed generation of oxygen. Furthermore, an electrostatic spray deposition method can be particularly suitably applied as described above due to the optimization of the voltage of a nozzle and coating spraying amount during electrostatic spraying, and can be a method optimized for the manufacturing method according to an embodiment of the present invention.

The active layer composition for a reduction electrode includes a metal precursor mixture containing a ruthenium-based compound, a platinum-based compound and a cerium-based compound and an organic solvent containing an alcohol-based compound and an amine-based compound.

The ruthenium-based compound can be one or more selected from the group consisting of ruthenium hexafluoride (RuF₆), ruthenium (III) chloride (RuCl₃), ruthenium (III) chloride hydrate (RuCl₃.×H₂O), ruthenium (III) bromide (RuBr₃), ruthenium (III) bromide hydrate (RuBr₃.×H₂O), ruthenium (III) iodide (RuI₃), ruthenium (III) iodide hydrate (RuI₃.×H₂O), and acetic acid ruthenium salt. Among the above, ruthenium (III) chloride hydrate is preferable.

The platinum-based compound can be one or more selected from the group consisting of chloroplatinic acid hexahydrate (H₂PtCl₆.6H₂O), diamine dinitro platinum (Pt(NH₃)₂(NO)₂), platinum (IV) chloride (PtCl₄), platinum (II) chloride (PtCl₂), potassium tetrachloroplatinate (K₂PtCl₄), and potassium hexachloroplatinate (K₂PtCl₆). Among the above, chloroplatinic acid hexahydrate is preferable.

Platinum can suppress the overvoltage of a reduction electrode for electrolysis and minimize the deviation between the initial performance of the reduction electrode for electrolysis and the performance thereof after a predetermined period of time. As a result, platinum can reduce separate activation processes to the minimum for the reduction electrode for electrolysis, and furthermore, can ensure the performance of the reduction electrode.

By further including a platinum precursor, an effect exhibited when not just adding platinum as an active ingredient but adding ruthenium and platinum, that is, two or more platinum group metals as active ingredients can be achieved. In this case, based on the fact that the performance of a reduction electrode is improved and the deviation between the initial performance and the performance after activation of the reduction electrode is small, it can be seen that the performance of an electrode operated in actual fields is stable and electrode performance evaluation results are reliable.

The platinum-based compound can be included in an amount of 0.01-0.7 mole or 0.02-0.5 mole based on 1 mole of the ruthenium-based compound. Among the above, it is preferable that the platinum-based compound is included in an amount of 0.02-0.5 mole, and more preferably 0.1-0.5 mole.

When the above range is met, the overvoltage of a reduction electrode for electrolysis can be significantly reduced. In addition, since the initial performance of a reduction electrode for electrolysis and the performance thereof after a predetermined period of time are maintained to be constant, an activation process of the reduction electrode for electrolysis is not required. Accordingly, the time and cost required for an activation process of a reduction electrode for electrolysis can be reduced.

A cerium-based compound is one or more selected from the group consisting of cerium (III) nitrate hexahydrate (Ce(NO₃)₃.6H₂O), cerium (IV) sulfate tetrahydrate (Ce(SO₄)₂.4H₂O), and cerium (III) chloride heptahydrate (CeCl₃.7H₂O). Among the above, cerium (III) nitrate hexahydrate is preferable.

The cerium-based compound can be included in an amount of 0.01-0.5 mole or 0.05-0.35 mole based on 1 mole of the ruthenium-based compound. Among the above, it is preferable that the cerium-based compound is included in an amount of 0.05-0.35 mole.

When the above-mentioned range is met, the durability of a reduction electrode for electrolysis is improved, so that it is possible to minimize the loss of ruthenium in an active layer of the electrode for electrolysis during activation or electrolysis.

The organic solvent includes an amine-based compound and an alcohol-based compound, and the amine-based compound can have an effect of reducing the crystal phase of a ruthenium oxide when coating an electrode. In addition, by including an amine-based compound, the size of the bed structure of a lanthanide metal, specifically a cerium oxide, can be increased, and the network structure of a cerium oxide formed therefrom can serve to fix ruthenium oxide particles more firmly. Consequently, the durability of the electrode can be improved thereby. As a result, even when the electrode is operated for a long time, peeling caused by other internal and external factors, such as aging, can be significantly reduced.

The active layer composition of a reduction electrode can include the amine-based compound in an amount of 0.5-10 parts by volume, preferably 1-8 parts by volume, and more preferably 2-6 parts by volume based on 100 parts by volume of the organic solvent. When the amine-based compound is included in the above range, in an active layer of a reduction electrode, the formation of the network structure of a lanthanide metal oxide and the fixing mechanism of platinum group metal oxide particles according to the structure formation can be optimized. As a result, the improvement of durability and the reduction of peeling can be more efficiently achieved.

The type of the amine-based compound is as described above.

One or more alcohol-based compounds can be included, and the alcohol-based compound can be selected from a primary alkyl alcohol and an alkoxyalkyl alcohol. The primary alkyl alcohol can be alcohol having an alkyl group having 1 to 4 carbon atoms, for example, methanol, ethanol, n-propanol, isopropanol, n-butanol, isobutanol, sec-butanol, or tert-butanol.

In addition, the alkoxyalkyl alcohol has an alkyl group to which an alkoxy group having 1 to 4 carbon atoms is coupled as a substituent, and the alkyl group can also have 1 to 4 carbon atoms. For example, the alkoxy group can be methoxy, ethoxy, n-propoxy, isopropoxy, n-butoxy, sec-butoxy, isobutoxy or tert-butoxy, and an alcohol parent can be a material exemplified above as the primary alkyl alcohol.

The alcohol-based compound can be two or more selected from the primary alkyl alcohol and the alkoxyalkyl alcohol, but preferably, can be one or more each selected therefrom. For example, it can be a combination in which isopropanol can be selected as the primary alkyl alcohol and 2-butoxyethanol can be selected as the alkoxyalkyl alcohol. When two or more alcohol-based solvents, in particular, one or more alcohol-based solvents from each group are included as described above, the uniformity of coating during the formation of an active layer can be ensured, and accordingly, the entire area of an electrode can have a uniform composition.

When the active layer composition according to an embodiment of the present invention includes an amine-based compound and an alcohol-based compound as an organic solvent in addition to metal precursors which are active ingredients, the network structure of a lanthanide metal oxide can be more firmly formed compared to when not used together, so that the durability improvement effect can be maximized.

The concentration of the active layer composition of a reduction electrode can be 15-80 g/L, preferably 20 to 75 g/L. When the above range is met, the standard deviation of the ruthenium composition is lowered and the overvoltage of the reduction electrode can also be significantly reduced.

The method for manufacturing a reduction electrode for electrolysis according to an embodiment of the present invention can further include a step of preparing a hydrogen adsorption layer after the coating step.

The configuration of the hydrogen adsorption layer is the same as described above, and the hydrogen adsorption layer can be prepared by a thermal decomposition method, or can be prepared by fixing one or more selected from the group consisting of a tantalum oxide, a nickel oxide, and carbon on the surface of the active layer using an appropriate resin followed by coating, or followed by pressing. Alternatively, the hydrogen adsorption layer can be prepared by melt plating, chemical vapor deposition, physical vapor deposition, vacuum deposition, sputtering, or ion plating.

### EXAMPLES

Hereinafter, the present invention will be described in more detail with reference to Examples and Experimental Examples. However, the present invention is not limited by these Examples and Experimental Examples. Examples according to the present invention can be modified into other various forms, and the scope of the present invention should not be construed as being limited to Examples described below. Examples of the present invention are provided to more fully describe the present invention to those skilled in the art.

### Example 1

### 1) Preparing Active Layer Composition of Reduction Electrode for Electrolysis

2.41 mmol of ruthenium (III) chloride hydrate (RuCl₃.×H₂O) (Manufacturer: Heraeus), 0.241 mmol of chloroplatinic acid hexahydrate (H₂PtCl₆.6H₂O) (Manufacturer: Heesung Metals), and 0.482 mmol of cerium (III) nitrate hexahydrate (Ce(NO₃)₃.6H₂O) (Manufacturer: Sigma-Aldrich) were sufficiently dissolved in 2.375 mL of isopropyl alcohol (Manufacturer: Daejung Chemicals & Metals) and 2.375 mL of 2-butoxyethanol (Manufacturer: Daejung Chemicals & Metals), and then 0.25 ml of n-octylamine (Manufacturer: Daejung Chemicals & Metals) was introduced thereto and mixed to prepare a catalyst composition for a reduction electrode for electrolysis.

### 2) Preparing Coating Solution

The catalyst composition for a reduction electrode for electrolysis was stirred for 24 hours at 50° C. to prepare a coating solution having a concentration of 33.3 g/L.

### 3) Manufacturing Reduction Electrode for Electrolysis

The surface of a nickel substrate (Thickness: 200 μm, purity: 99% or greater) was sand blasted with an aluminum oxide (120 mesh) under a 0.8 kgf/cm² condition to form irregularities. The nickel substrate formed with irregularities was immersed in a sulfuric acid aqueous solution (5 M) at 80° C. for 3 minutes to form fine irregularities. Thereafter, the nickel substrate formed with fine irregularities was cleaned with distilled water and then sufficiently dried to prepare a pre-treated nickel substrate.

The coating solution was applied to the pre-treated nickel substrate. At this time, the applying was performed such that the active layer composition was applied by an electrostatic spray deposition method under the condition of nozzle voltage 20 kV, spraying volume per time 50 ml, spraying rate 0.8 mL/min, and at room temperature, dried in a convection-type drying oven of 180° C. for 10 minutes, and then placed into an electric furnace of 480° C. to be heat treated for 10 minutes. The coating, drying, and heat treatment were each repeatedly performed until ruthenium in the active layer became 5 wt %, followed by performing heat treatment at 500° C. for 1 hour to manufacture a reduction electrode for electrolysis.

### Example 2

A reduction electrode for electrolysis was manufactured in the same manner as in Example 1 except that a coating solution having a concentration of 52 g/L was prepared in the preparation of a coating solution.

### Example 3

A reduction electrode for electrolysis was manufactured in the same manner as in Example 1 except that a coating solution having a concentration of 70 g/L was prepared in the preparation of a coating solution.

### Example 4

A reduction electrode for electrolysis was manufactured in the same manner as in Example 1 except that a coating solution having a concentration of 52 g/L was prepared in the preparation of a coating solution and that the molar ratio of Ru, Pt, and Ce was changed as described in Table 1 below.

### Example 5

A reduction electrode for electrolysis was manufactured in the same manner as in Example 1 except that a coating solution having a concentration of 52 g/L was prepared in the preparation of a coating solution and that the molar ratio of Ru, Pt, and Ce was changed as described in Table 1 below.

### Comparative Example 1

A reduction electrode for electrolysis was manufactured in the same manner as in Example 1 except that a brushing method was applied in the manufacturing of a reduction electrode for electrolysis.

### Comparative Example 2

A reduction electrode for electrolysis was manufactured in the same manner as in Example 2 except that a brushing method was applied in the manufacturing of a reduction electrode for electrolysis.

### Comparative Example 3

A reduction electrode for electrolysis was manufactured in the same manner as in Example 2 except that a non-electrostatic spray deposition method was applied in the manufacturing of a reduction electrode for electrolysis.

### Comparative Example 4

A reduction electrode for electrolysis was manufactured in the same manner as in Example 2 except that an amine was not introduced in the manufacturing of a reduction electrode for electrolysis.

### Comparative Example 5

A reduction electrode for electrolysis was manufactured in the same manner as in Comparative Example 2 except that an amine was not introduced in the manufacturing of a reduction electrode for electrolysis.

### Comparative Example 6

A reduction electrode for electrolysis was manufactured in the same manner as in Example 2 except that platinum was not applied in the manufacturing of a reduction electrode for electrolysis.

### Comparative Example 7

A reduction electrode for electrolysis was manufactured in the same manner as in Comparative Example 2 except that platinum was not applied in the manufacturing of a reduction electrode for electrolysis.

The contents of main components of Examples and Comparative Examples are summarized and shown in Table 1 below.

TABLE 1

| | | Amine-based | |
|---|---|---|---|
| | | compound¹⁾ | |
| Classification | Ru:Pt:Ce | (n-octylamine) | Applied method |
| Example 1 | 5:0.5:1 | 5 | Electrostatic spray |
| | | | deposition method |
| Example 2 | 5:0.5:1 | 5 | Electrostatic spray |
| | | | deposition method |
| Example 3 | 5:0.5:1 | 5 | Electrostatic spray |
| | | | deposition method |
| Example 4 | 6:0.5:1 | 5 | Electrostatic spray |
| | | | deposition method |
| Example 5 | 4:0.5:1 | 5 | Electrostatic spray |
| | | | deposition method |
| Comparative | 5:0.5:1 | 5 | Brushing method |
| Example 1 | | | |
| Comparative | 5:0.5:1 | 5 | Brushing method |
| Example 2 | | | |
| Comparative | 5:0.5:1 | 5 | Non-electrostatic spray |
| Example 3 | | | deposition method |
| Comparative | 5:0.5:1 | Not introduced | Electrostatic spray |
| Example 4 | | | deposition method |
| Comparative | 5:0.5:1 | Not introduced | Brushing method |
| Example 5 | | | |
| Comparative | 5:0:1 (Pt not | 5 | Electrostatic spray |
| Example 6 | introduced) | | deposition method |
| Comparative | 5:0:1 (Pt not | 5 | Brushing method |
| Example 7 | introduced) | | |

¹⁾Introduction parts by volume of amine-based compound (n-octylamine) based on 100 parts by volume of organic solvent.

### Experimental Example 1

The degree of distribution of metals in the active layer of the reduction electrode for electrolysis of each of Examples and Comparative Examples was analyzed, and the number of times of coating repeated which was required until the content of ruthenium became about 5 wt % was counted. The results are shown in Table 2 below.

Specifically, each reduction electrode was prepared in a 0.6 m in width and 0.6 m in length dimension and uniformly divided into 16 pixels. Thereafter, using three points for each pixel, the weight ratio of ruthenium and cerium in each pixel was measured using an XRF (X-ray fluorescence) component analyzer. Thereafter, using the each obtained wt % of ruthenium, a dispersion ((V(x)) was calculated through Equation 1 above, and using the dispersion, a standard deviation (σ) was calculated through Equation 2 above.

TABLE 2

| | | | N/Ru | | | Concentration |
|---|---|---|---|---|---|---|
| | Ru | Weight | (mol %) | Standard | Number | of coating |
| | content | ratio of | in active | deviation | of times | solution |
| Classification | (mol %) | Ru and Ce | layer | of Ru | of coating | (g/L) |
| Example 1 | 5.41 | 1.25:1 | 43 | 0.27 | 16 | 33.3 |
| Example 2 | 5.30 | 1.14:1 | 42 | 0.24 | 10 | 52.0 |
| Example 3 | 5.29 | 1.09:1 | 46 | 0.21 | 9 | 70.0 |
| Example 4 | 5.54 | 1.29:1 | 38 | 0.21 | 10 | 52.0 |
| Example 5 | 5.08 | 0.89:1 | 46 | 0.27 | 10 | 52.0 |
| Comparative | 5.72 | 1.36:1 | 43 | 0.42 | 21 | 33.3 |
| Example 1 | | | | | | |
| Comparative | 5.50 | 1.16:1 | 44 | 0.63 | 14 | 52.0 |
| Example 2 | | | | | | |
| Comparative | 4.57 | 0.94:1 | 49 | 1.00 | 12 | 52.0 |
| Example 3 | | | | | | |
| Comparative | 5.23 | 1.12:1 | 13 | 0.25 | 10 | 52.0 |
| Example 4 | | | | | | |
| Comparative | 5.13 | 1.20:1 | 15 | 0.69 | 13 | 52.0 |
| Example 5 | | | | | | |
| Comparative | 5.26 | 1.12:1 | 46 | 0.26 | 10 | 52.0 |
| Example 6 | | | | | | |
| Comparative | 5.22 | 1.05:1 | 44 | 0.75 | 13 | 52.0 |
| Example 7 | | | | | | |

In the case of Examples 1 to 5, the standard deviation of the ruthenium content was all as low as 0.4 or less. From the result, it can be confirmed that active materials were uniformly distributed in the active layers of Examples. However, in the case of some Comparative Examples in which an electrostatic spray deposition method was not applied, it can be seen that the uniformity was considerably deteriorated as standard deviation values of greater than 0.4 were derived. From the result, it can be seen that when an electrostatic spray deposition method is applied, compositions of active ingredients present in an active layer of a reduction electrode can be fairly uniformly distributed over the entire area.

In addition, in the case of Example 1 and Comparative Example 1 in which the same coating solution concentration was applied, even though coating was performed 5 times less in Example 1, a desired ruthenium content was achieved, and at the same time, uniformity was secured. The result can be clearly confirmed through Example 2 and Comparative Examples 2 and 3.

### Experimental Example 2

The reduction electrode of each of Examples and Comparative Examples, a Pt wire as a counter electrode, and a Hg/HgO electrode as a reference electrode were immersed in a NaOH aqueous solution (32 wt %) to manufacture a half cell.

Measurement of Voltage

The half cell was treated for 1 hour under the current density condition of −6 A/cm², and then the voltage of each reduction electrode was measured through a linear sweep voltammetry under the current density condition of −0.44 A/cm². The results are shown in Table 3.

Measurement of Durability

The change in the content of Ru before and after the electrolysis was measured for the half cell using a portable XRF (Olympus Corporation, Delta-professional XRF(X-ray Fluorescence spectrometry)), and the results are shown in Table 3 below.

TABLE 3

| | Ru content | Weight ratio of | Voltage | Ru residual rate |
|---|---|---|---|---|
| Classification | (mol %) | Ru and Ce | (V) | (%) |
| Example 1 | 5.41 | 1.25:1 | −1.075 | 99.8 |
| Example 2 | 5.30 | 1.14:1 | −1.083 | 99.6 |
| Example 3 | 5.29 | 1.09:1 | −1.087 | 98.4 |
| Example 4 | 5.54 | 1.29:1 | −1.095 | 99.5 |
| Example 5 | 5.08 | 0.89:1 | −1.101 | 99.6 |
| Comparative | 5.72 | 1.36:1 | −1.115 | 99.3 |
| Example 1 | | | | |
| Comparative | 5.50 | 1.16:1 | −1.131 | 99.8 |
| Example 2 | | | | |
| Comparative | 4.57 | 0.94:1 | −1.155 | 78.4 |
| Example 3 | | | | |
| Comparative | 5.23 | 1.12:1 | −1.120 | 94.6 |
| Example 4 | | | | |
| Comparative | 5.13 | 1.20:1 | −1.122 | 93.7 |
| Example 5 | | | | |
| Comparative | 5.26 | 1.12:1 | −1.136 | 99.6 |
| Example 6 | | | | |
| Comparative | 5.22 | 1.05:1 | −1.142 | 99.5 |
| Example 7 | | | | |

Referring to Table 2, in the case of Example 1 to Example 5, not only was ruthenium contained in an appropriate amount but also the standard deviation thereof was low. Therefore, it can be confirmed that the overvoltage of each reduction electrode for electrolysis was reduced. However, in the case of Comparative Example 1 to Comparative Example 3 and Comparative Example 5 and Comparative Example 7, even though ruthenium was contained in an appropriate amount, the standard deviation thereof was high, so that it can be confirmed that the overvoltage of each reduction electrode for electrolysis was not reduced when compared with Example 1 to Example 5.

In addition, in the case of Comparative Example 6 and Comparative Example 7 in which Pt was not introduced, the overvoltage each thereof was shown to be greater than that in Example 2 and Comparative Example 2, which are respectively the reference thereof. In the case of Comparative Examples 4 and 5 in which amine was not introduced during the manufacturing, it can be confirmed that there was a loss in terms of durability. In the case of Comparative Example 3 to which a non-electrostatic spray deposition method was applied, it can be confirmed that durability was greatly reduced.

1. A reduction electrode for electrolysis comprising a metal substrate and an active layer positioned on at least one surface of the metal substrate, wherein:
the active layer includes a ruthenium oxide, a platinum oxide, and a cerium oxide;
when the active layer is uniformly divided into a plurality of pixels, the standard deviation of the composition of ruthenium between the plurality of pixels uniformly divided is 0.4 or less; and
N atoms in the active layer are present in an amount of 20-60 mol % based on ruthenium.

2. The reduction electrode for electrolysis of claim 1, wherein the standard deviation of the composition of ruthenium is 0.35 or less.

3. The reduction electrode for electrolysis of claim 1, wherein the active layer comprises, based on 100 mol % in total of metal components in the active layer, the ruthenium in an amount of 3-7 mol %.

4. The reduction electrode for electrolysis of claim 1, wherein the active layer comprises cerium and ruthenium in a molar ratio of 1:1 to 1:1.5.

5. The reduction electrode for electrolysis of claim 1, further comprising a hydrogen adsorption layer positioned on the active layer and including one or more selected from the group consisting of a tantalum oxide, a nickel oxide, and carbon.

6. A method for manufacturing the reduction electrode for electrolysis of claim 1, the method comprising:
a coating step of applying, drying, and heat treating an active layer composition for a reduction electrode on at least one surface of a metal substrate, wherein:
the applying is performed by an electrostatic spray deposition method; and
the active layer composition for a reduction electrode includes a metal precursor mixture containing a ruthenium-based compound, a platinum-based compound, a cerium-based compound, and an organic solvent containing an alcohol-based compound and an amine-based compound.

7. The method of claim 6, wherein the metal precursor mixture comprises, based on 1 mole of the ruthenium-based compound, the platinum-based compound in an amount of 0.01-0.7 mole and the cerium-based compound in an amount of 0.01-0.5 mole.

8. The method of claim 6, wherein the amine-based compound is one or more selected from the group consisting of n-octylamine, t-octylamine, isooctylamine, trioctylamine, oleylamine, tributylamine, and cetyltrimethylammonium bromide.

9. The method of claim 6, wherein the alcohol-based compound comprises one or more selected from the group consisting of a primary alkyl alcohol having an alkyl group of 1 to 4 carbon atoms, and an alkoxyalkyl alcohol having an alkyl group of 1 to 4 carbon atoms to which an alkoxy group of 1 to 4 carbon atoms is coupled as a substituent.

10. The method of claim 6, wherein the alcohol-based compound comprises:
a primary alkyl alcohol having an alkyl group having 1 to 4 carbon atoms; and
an alkoxyalkyl alcohol having an alkyl group of 1 to 4 carbon atoms to which an alkoxy group of 1 to 4 carbon atoms is coupled as a substituent.

11. The method of claim 6, further comprising a step of preparing a hydrogen adsorption layer after the coating step.
